(19) United States
(12) Patent Application Publication
(10) Pub. No.: US 2013/0317958 A1
(43) Pub. Date: Nov. 28, 2013

(54) METHOD AND SYSTEM FOR MAINTAINING STATUS CORRESPONDING TO EACH CHEQUE LEAVES OF A CHEQUE-BOOK

(71) Applicant: Kaniyanoor Seshadri Rajasekaran, Bangalore (IN)

(72) Inventor: Kaniyanoor Seshadri Rajasekaran, Bangalore (IN)

(73) Assignee: INFOSYS LIMITED, Bangalore, KA (IN)

(21) Appl. No.: 13/984,814

(22) PCT Filed: Feb. 25, 2011
(86) PCT No.: PCT/IN2011/000115

§ 371 Date: Aug. 9, 2013

(51) Int. Cl. G06Q 40/00

(52) U.S. Cl. CPC G06Q 40/108
USPC 705/33

(57) ABSTRACT

A method and a system have been described for maintaining a plurality of statuses corresponding to each of one or more cheque leaves of a cheque-book. Each of the plurality of statuses depicts a cheque leafs corresponding life-cycle stage. Various examples of the plurality of statuses may include, but are not limited to, “Issued but not acknowledged for use”, “Unused”, “Passed”, “Stopped”, “Revoked”, “Cautioned”, “Destroyed”, “Return Paid”, and “Rejected”. The method described above includes assigning a default status to each cheque leaf. The default status is assigned to the cheque leaf while issuing the cheque-book to a customer. Once the cheque-book is issued, the default status and one or more statuses corresponding to each cheque leaf are maintained. Each of the one or more statuses is assigned to the cheque leaf based on the occurrence of a corresponding event from a list of pre-defined events.

### FIELD OF THE INVENTION

The present invention relates, in general, to the field of banking industry. More specifically, the invention relates to a method and a system for maintaining a status corresponding to each cheque leaves of a cheque-book.

### BACKGROUND

Banking industry plays a vital role in all the economic, financial, and business activities. Almost all payment services are conducted through banks. All businesses, including individuals and government alike, essentially look for bank accounts. Bank offers a host of financial services to individuals, such as checking accounts, savings accounts, money market accounts, loans, time deposits, cash management services, and so forth. Similarly, bank provides services to business sectors by offering debts for both—the start ups and the existing companies.

Initially, banking was viewed as one of the most traditional sectors in the economy and business markets; however, currently, banking is following not only its traditional ways, but also new channel based ways—such as online banking. Online banking has evolved as a result of technological development and growth of the Internet. The evolution of online banking, also known as Internet banking or Net banking, has brought a significant change in the banking industry. Online banking offers additional services to individuals, including ability to transfer money from one account to another, bill payments, investments, e-tax payment, check history, reorders, stop payments, check credit card balances and statements, complete online loan applications, secure interactive messaging with staff and the like.

Bank facilitates a number of modes for conducting financial transactions, for example, Automated Teller Machine (ATM) cards, debit cards, credit cards, shopping cards, fast cash, cheque-book, etc. Of these, cheque-book is the most traditional way of conducting financial transactions. Initially, at the time of opening an account with a bank, the bank provides cheque-book facility which operates from the customer's (or individual's) saving accounts with cheques or current account or accounts with cheques facility. As known in the art, a cheque is a piece of paper that illustrates an unconditional order given to the bank to pay a certain amount of money to the named person or his/her name. More particularly, the cheque represents an authorized document used for the payment. Nowadays, most of the individuals may not prefer conducting financial transactions using cheques; however, conducting financial transactions using cheques has many advantages. For example, the customer does not need to worry about carrying a large amount of cash as cheques are widely accepted. Similarly, cheques eliminate the need to first withdraw cash from the bank before making a payment. Furthermore, making payments or conducting financial transactions using cheques is simple, flexible, and easy. Moreover, cheques can be posted/stationed easily without any risk that is associated with sending the cash. Additionally, cheques can be used for conducting different types of financial transactions, such as bill payments and money transfer. Hence, conducting financial transactions using cheques is beneficial; however, one of the most challenging tasks associated with the cheques is to maintain each cheque status based on the current event or usage by the customer.

A number of methods and solutions are available in the market for maintaining record/status of cheques issued to a customer. However, there are a lot of disadvantages associated with the existing solutions. One of the disadvantages is that these solutions provide a manual option for maintaining status of the cheques. The solutions further focus on maintaining the cheque's status only when the transactions conducted by the cheques are successful. However, these solutions fail to maintain the cheque's status when other activities/events take place. For example, these solutions are not capable of maintaining the status corresponding to scenarios when the transactions carried using the cheques are not successful, or when payment on the cheque is stopped by the customer. Pursuant to this, these solutions fail to maintain multiple statuses of each cheque based on the activity/event. These solutions further fail to disclose the automatic approach of updating each cheque's status based on the occurrence of various activities/events. Further, these solutions do not provide any measures for validating the cheque's status, thereby failing to maintain the cheque's correct/actual status. Moreover, these solutions do not provide any mechanism for enabling customers to enquire about the cheque's status through multiple channels. In addition to this, the solutions focus on saving the status of multiple cheques in a separate memory, thereby consuming a significant amount of memory.

In view of the aforementioned challenges, there is a need for a method and a system for providing a banking solution which facilitates the automatic maintenance of multiple statuses of each cheque of a cheque-book. There lies a further need for automatically updating the status of each cheque based on the occurrence of an event/activity. Further, there exists a need for validating each cheque's status to maintain each cheque's correct/actual status. Moreover, there exists a need for storing/maintaining the status of multiple cheques in such a manner to reduce the amount of memory consumed. Additionally, there lies a need for a method and a system for enabling customers to enquire about each cheque's status anytime through multiple channels.

### SUMMARY

The present invention discloses a method for maintaining a status corresponding to each of one or more cheque leaves of a cheque-book. The cheque leaves can be used for conducting financial transactions, such as bill payments and funds transfer. The method includes issuing the cheque leaves to a customer with each of them having a default status. After the cheque leaves have been issued, each cheque leaf status is updated by appending a current status to the previous status. The current status is appended based on the occurrence of an event from a list of pre-defined events. Once the status is updated, then the updated status of each of the cheque leaves is maintained in a pre-defined format. Moreover, the process of updating and maintaining the status is repeated until at least one event from the list of pre-defined events occurs. The at least one event is different from the event as described above. Additionally, the status disclosed above depicts a plurality of statuses pertaining to a life-cycle stage of each of the cheque leaves.

The present invention further describes a method for maintaining a plurality of statuses corresponding to each of one or more cheque leaves of a cheque-book. Each of the statuses depicts a corresponding life-cycle stage of a cheque leaf. The cheque leaves are used for conducting different financial transactions. Various examples of the plurality of statuses may include, but are not limited to, “Issued but not acknowledged for use”, “Unused”, “Passed”, “Stopped”, “Cautioned”, “Destroyed”, “Return Paid”, and “Rejected”. The method described above includes assigning a default status to each of the cheque leaves while issuing the cheque-book to a customer. Once the cheque-book is issued, the default status and one or more statuses corresponding to the cheque leaf are maintained. The one or more statuses form a part of the plurality of statuses. Moreover, each status of the statuses is assigned to the cheque leaf based on the occurrence of a corresponding event from a list of pre-defined events.

Further, the present invention discloses a system for maintaining a status corresponding to each of one or more cheque leaves of a cheque-book. The system includes an issuing module configured for issuing the cheque leaves to a customer, wherein each of the cheque leaves has a default status. The system includes, an updating module configured for updating the status by appending a current status to the status of each of the cheque leaves. The current status is appended based on the occurrence of an event from a list of pre-defined events. The event may include “Acknowledgement on one or more cheque leaves”. Moreover, the system includes a maintenance module configured for maintaining the status of each of the cheque leaves in a pre-defined format. The pre-defined format may correspond to a compact way of storing the status of each of the cheque leaves. Moreover, the steps performed by the updating module and the maintenance module are repeated to further update and maintain the status when at least one event from the list of pre-defined events occurs. The at least one event is different from the event described above. The at least one event may be, for instance, “Transaction Maintenance”, “Inward Clearing”, “Stop Payment of a Cheque Leaf”, “Revoke Payment of a Stopped Cheque Leaf”, “Removal of Caution”, and “Paid Cheque Leaf Return”. Additionally, the status disclosed above depicts a plurality of statuses of a life-cycle stage of each of the cheque leaves.

Additionally, the present invention discloses a Computer Program Product (CPP) for use with a computer, the CPP includes a computer usable medium having a computer readable program code embodied therein for maintaining a status corresponding to each of one or more cheque leaves of a cheque-book. Each of the cheque leaves has a different cheque number or a serial number and further can be used for conducting various financial transactions. The computer readable program code includes a program instruction means for issuing the cheque leaves to a customer, wherein each of the cheque leaves has a default status. The default status may be, but is not limited to, “Issue but not acknowledged for use”, and “Unused”. The computer readable program code further includes a program instruction means for updating the status by appending a current status to the status corresponding to each of the cheque leaves. The current status is appended based on the occurrence of an event from a list of pre-defined events. Further, the computer readable program code includes a program instruction means for maintaining the status of each of the cheque leaves in a pre-defined format. The pre-defined format may correspond to a compact way of storing the status of each of the cheque leaves. Additionally, the program instructions for updating and maintaining the status as described above are repeated to further update and maintain the status when at least one event from the list of pre-defined events occurs, wherein the at least one event is different from the event. The status disclosed above depicts a plurality of statuses of a life-cycle stage of each of the cheque leaves.

### BRIEF DESCRIPTION OF THE DRAWINGS

Various embodiments of the invention will, hereinafter, be described in conjunction with the appended drawings provided to illustrate and not to limit the invention, wherein like designations denote like elements, and in which:

FIG. 1 illustrates an exemplary environment in which various embodiments of the present invention may be practiced;

FIG. 2 depicts a system exemplifying system elements (or modules) for maintaining a status corresponding to each cheque leaves of a cheque-book, in accordance with an embodiment of the invention;

FIG. 3 represents a flow chart for maintaining a status corresponding to each cheque leaves of a cheque-book, in accordance with an embodiment of the present invention;

FIG. 4 illustrates a table depicting multiple statuses of each cheque leaves of a cheque-book, in accordance with an embodiment of the present invention;

FIG. 5 represents an exemplary screenshot illustrating various details required while issuing a cheque-book, in accordance with an embodiment of the present invention;

FIG. 6 shows an exemplary screenshot depicting warning exceptions occurred while issuing a cheque-book, in accordance with an embodiment of the present invention;

FIG. 7 depicts an exemplary screenshot showing issuance of a selected cheque-book, in accordance with an embodiment of the present invention;

FIG. 8 is an exemplary screenshot depicting a result screen for inquiry of one or more cheque leaves of a cheque-book, in accordance with an embodiment of the present invention;

FIG. 9 represents an exemplary table depicting record details of each cheque leaves of a cheque-book, in accordance with an embodiment of the present invention;

FIG. 10 shows an exemplary screenshot illustrating various details associated with each cheque leaves of a cheque-book, in accordance with an embodiment of the present invention;

FIG. 11 illustrates an exemplary screenshot displaying one or more statuses of each cheque leaves of a cheque-book, in accordance with an embodiment of the present invention;

FIG. 12 demonstrates an exemplary screenshot for modifying status of a cheque leaf, in accordance with an embodiment of the present invention; and

FIG. 13 represents an exemplary screenshot for uploading details of each cheque leaves of a cheque-book, in accordance with an embodiment of the present invention.

### DETAILED DESCRIPTION OF THE DRAWINGS

Broadly, the present invention discloses a unique approach for maintaining a status of each cheque during its life-cycle. Each cheque can be used for conducting financial transactions. Various examples of the financial transactions may include, but are not limited to, bill payments, funds transfer, investments, and shopping. In particular, the main objective of the present invention is to maintain multiple statuses corresponding to each cheque of a cheque-book. Examples of the multiple statuses of each cheque may include, but are not limited to, “Issued but not acknowledged for use”, “Unused”, “Passed”, “Stopped”, “Revoked”, “Cautioned”, “Destroyed”, “Return Paid”, and “Rejected”. The maintenance of the multiple statuses of each cheque helps the customer to track the actual status of each cheque anytime. In other words, these multiple statuses help the customer to know about a particular cheque position in the processing cycle, as well as provide information about its life-cycle. Moreover, a customer can also reconcile cheque payments using these statuses. Additionally, the maintenance of the multiple statuses of each cheque prevents the occurrence of fallacious activities on the cheque, such as duplicate payment on a cheque, payment on a stopped cheque. Therefore, the wrong payment in the cheque's life-cycle is reduced.

For the sake of simplicity and clarity, the terminology to be used in detailed description has been illustrated in the table below. The table depicts one or more terms with their corresponding description/meaning.

| Terms | Description |
|---|---|
| Cheque leaf | An individual cheque may be termed as a cheque leaf. |
| | The cheque leaf may often be called a cheque |
| Cheque leaves | A collection of more than one cheque leaf |
| Cheque-book | A booklet containing a number of cheque leaves in |
| | series |
| Customer | A person having an account with the bank. In this |
| | context, cheque-book is issued to the customer. The |
| | customer may often be called an account holder (A/c |
| | holder) |
| Account Id | The customer's account number to which the cheque- |
| | book is issued |
| Default status | Each cheque leaf's fixed status when it is issued |
| | by a bank |
| Bank Agent | A bank employee to assist the customer |

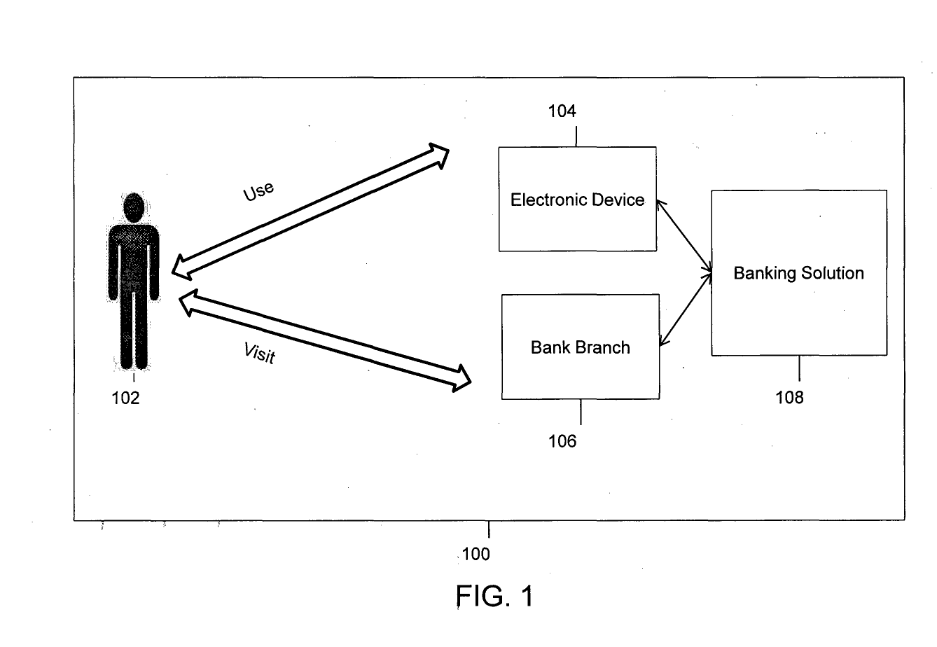

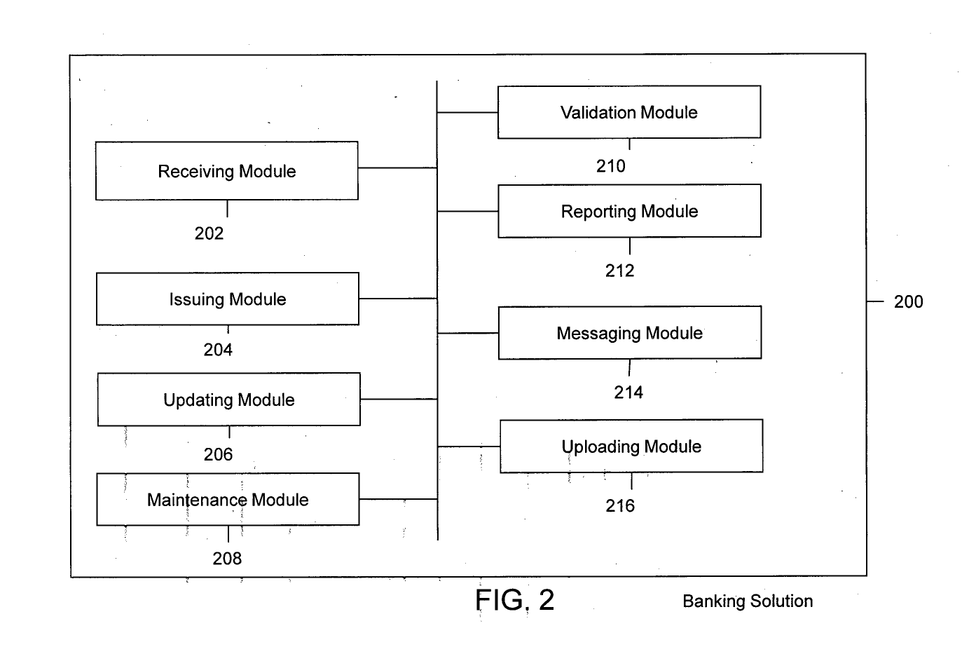

FIG. 1 illustrates an exemplary environment 100 in which various embodiments of the present invention may be practiced. To describe the exemplary environment as illustrated in FIG. 1, references will be made to FIGS. 2 & 3, although, it will be apparent to those skilled in the art that the implementation details of this environment can be applicable to any other embodiment of the present invention.

A life-cycle of a cheque leaf exemplifies a chain of multiple statuses, wherein the cheque leaf passes from one status to another based on the occurrence of an event. The life-cycle of a cheque leaf starts when it is issued from a bank to a customer and ends when it is presented or paid or destroyed as a part of the account closure. Additionally, a life-cycle stage of the cheque leaf denotes one status applicable at a given point of time.

Exemplary environment 100, as shown in FIG. 1, includes a customer 102, an electronic device 104, a bank branch 106, and a banking solution 108. In accordance with an embodiment of the present invention, electronic device 104 may be referred to as a processing device. In accordance with an embodiment of the present invention, bank branch 106 may be substituted by a financial institution or similar entities. Further, bank branch 106 may be referred to as a bank.

Initially, when customer 102 wishes to open an account with a bank, he/she may visit bank branch 106 and may request a bank agent for opening an account with the bank. Various examples of the account may include a current account, a checking account, a savings account, and so forth. As a part of opening an account with the bank, a cheque-book may be issued to customer 102. In accordance with another embodiment of the present invention, a cheque-book may be issued to customer 102 based on the bank's re-order or re-issue policy, only when customer 102 has an existing account with the bank. In accordance with further embodiment of the present invention, a cheque-book may be issued to customer 102 when requested by him/her. The request may be sent by customer 102 using electronic device 104 through multiple channels. Various examples of electronic device 104 may include, but are not limited to, personal computers, laptop computers, mobile phones, Personal Digital Assistants (PDAs), Blackberry®, and smart phones. Examples of the multiple channels may include short message service (SMS), short code, interactive voice response (IVR), the Internet, customer care, unstructured supplementary service data (USSD), and so forth. In accordance with an embodiment of the present invention, the request received from customer 102 to issue/re-issue a cheque-book is validated by a bank agent through banking solution 108. For example, the request is validated to ascertain whether the customer's account number or the account ID exists.

Based on the embodiments described above, the cheque-book is issued lb customer 102 by bank branch 106. The cheque-book contains one or more cheque leaves. Each cheque leaf has a unique fixed digit serial number, for example, 10 digits, 12 digits, etc. Each cheque leaf has a plurality of statuses applicable at a single point of time, and further each status is driven by a corresponding event.

In accordance with an embodiment of the present invention, when the cheque leaves are in the bank's custody, no status is attached to them except the status that defines the cheque leaves are new and ready for issue to customer 102. Accordingly, at the time of issuing the cheque-book, a default status such as “Issued but not acknowledged for use” is associated with each cheque leaf by bank branch 106. This default status is further maintained by banking solution 108 in a pre-defined format. Once the cheque leaves are issued to customer 102 for their use, multiple statuses are applicable for each cheque leaf. Each of the multiple statuses is applicable at a single point of time. Further, banking solution 108 facilitates the maintenance of these multiple statuses of each cheque leaf. Various examples of the multiple statuses may include, but are not limited to, “Issued but not acknowledged for use”, “Unused”, “Passed”, “Stopped”, “Revoked”, “Cautioned”, “Destroyed”, “Return Paid”, and “Rejected”.

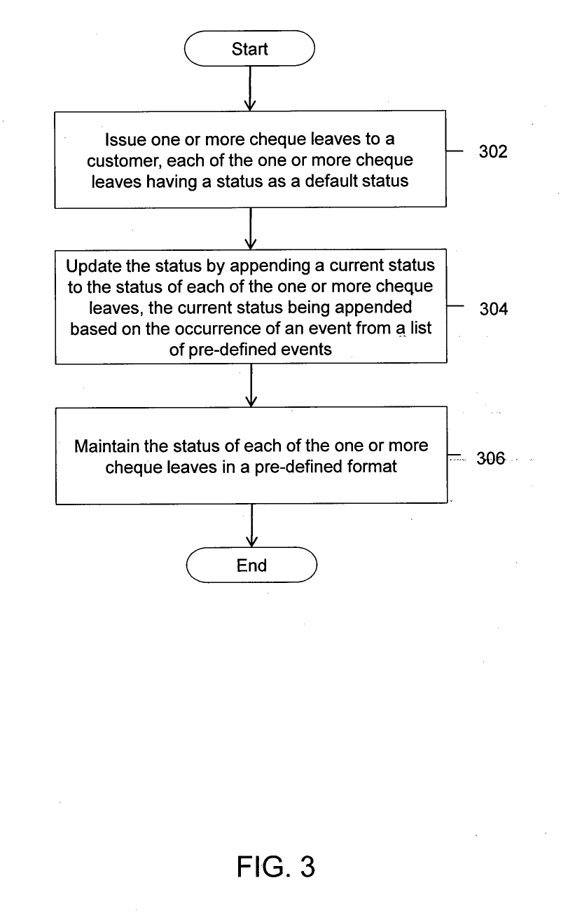

In accordance with various embodiments of the present invention, the multiple statuses of each cheque leaf have been described below and will be further described in detail in conjunction with FIG. 3.

Status 1—“Issued but not acknowledged for use”: This status signifies that the cheque leaf has been issued to customer 102 by bank branch 106 but it is yet to be acknowledged by customer 102 for use.

Status 2—“Unused”: This status expresses that the cheque leaf issued by customer 102 is acknowledged by customer 102 for use. Further, the status is applicable when the bank follows an acknowledgement based cheque issuing process. Before acknowledgement, if a cheque leaf comes for processing, it is processed as an exceptional transaction by banking solution 108.

Status 3—“Passed”: This status signifies that the cheque leaf is used by. customer 102 for conducting financial transaction, and further the transaction has been conducted successfully. Additionally, banking solution 108 ensures that the unused cheque leaf is presented for the transaction. Banking solution 108 further prompts appropriate error messages based on the status of the cheque leaf. In accordance with various embodiments of the present invention, a cheque leaf cannot be used for conducting transactions for scenarios such as a cheque leaf is not issued to the account, it is already passed, it is stopped/cautioned, or it is not in the usable status, i.e., it is destroyed.

Status 4—“Stopped”: The status describes that the cheque leaf is issued to customer 102, but the payment on the cheque leaf needs to be stopped for different reasons. Further, in accordance with various embodiments of the present invention, banking solution 108 performs a number of validation checks before updating the status of a cheque leaf to “Stopped”. For example, banking solution 108 ascertains whether the cheque leaf is already paid or not, stopped or not, issued or not, and destroyed or not. Accordingly, banking solution 108 allows for stop payment status change. Additionally, a single cheque leaf or one or more cheque leaves in series can be stopped.

Status 5—“Revoked”: The status signifies that the cheque leaf stopped for payment is revoked by customer 102. Banking solution 108 performs one or more validation checks before updating the cheque leaf's status. For example, banking solution 108 determines whether the cheque leaf is already stopped or not. Further, only the cheque leaf with status “Stopped” can be revoked. In accordance with an embodiment of the present invention, the status “Revoked” may be referred to as “Undo”.

Status 6—“Cautioned”: The status depicted herein describes that the cheque leaf is issued to the customer 102 but cannot be stopped due to various reasons. One of the reasons may include that the owner of the cheque leaf is not available. Further, this status ensures that the bank exercises caution when it presents the cheque leaf for payment. In addition, the cheque leaf with status “Cautioned” can be processed as an exceptional transaction by banking solution 108.

Status 7—“Destroyed”: This status expresses that the cheque leaf is not available for use by customer 102. Further, only unpaid cheque leaf or the cheque leaf with status “Unused” can be marked as destroyed.

Status 8—“Return paid”: The status describes that the cheque leaf paid by customer 102 is returned to customer 102 when the transaction conducted using the cheque leaf is successful. The cheque leaf is returned to customer 102 for his/her records. Additionally, the status is applicable when bank branch 106 follows a process of returning cheque leaves to customer 102 after conducting the successful transactions.

Status 9—“Rejection”: The status depicted herein demonstrates that the cheque leaf sent for the payment is to be rejected. The status has been introduced to handle certain specific markets where cheque leaf can be paid before but it can be rejected later.

Moreover, one or more of the multiple statuses are updated by banking solution 108 based on the occurrence of one or more events, and this process will be discussed in detail in conjunction with FIGS. 2 & 3. Additionally, banking solution 108 validates each cheque leaf's status before maintaining the status or updating each cheque leafs status.
Banking solution 108, as shown in FIG. 1, is a software application installed on the machines of bank agents. It facilitates various solutions related to banking operations. Various examples of the solutions provided by banking solution 108 may include, but are not limited to, status enquiry, status overview, status update, status modification, transaction enquiry, change passwords, balance checks, accounts overview, transfer overview, bill payments, and funds transfer. In accordance with another embodiment of the present invention, banking solution 108 may be installed on electronic device 104 used by customer 102. In accordance with further embodiment of the present invention, banking solution 108 may be a plug-in.

In accordance with an embodiment of the present invention, banking solution 108 may correspond to software components. In accordance with another embodiment of the present invention, banking solution 108 may correspond to hardware components with software modules running within the hardware components. In accordance with one more embodiment of the present invention, banking solution 108 may be a combination of software and hardware modules.

Various examples of networks through which bank machines and electronic devices can exchange information or data among themselves can be a Local Area Network (LAN), a Wide Area Network (WAN), a Wireless LAN, a Metropolitan Area Network (MAN), a Public Switched Telephone Network (PSTN), a Global Telecommunications Exchange (TELEX) network, a Global System for Mobile (GSM) communication network, a Code Division Multiple Access (CDMA) network, etc. In addition to this, bank machines and electronic devices in the various network topologies may communicate with each other using various network protocols such as Transport Control Protocol (TCP), Internet Protocol (IP), User Datagram Protocol (UDP), Simple Mail Transport Protocol (SMTP), Session Initiation Protocol (SIP), Post-Office Protocol (POP), Internet Relay Chat (IRC), and other protocols known in the art. Further, bank machines and electronic devices may include one or more Operating Systems (OS), such as MS Windows®, Linux, Unix®, and one or more data processing applications running on it.

FIG. 2 depicts a system 200 exemplifying system elements (or modules) for maintaining a status corresponding to each cheque leaves of a cheque-book, in accordance with an embodiment of the invention. To describe the system elements illustrated in FIG. 2, references will be made to FIGS. 1 & 3, although, it will be apparent to those skilled in the art that the implementation details of the system modules can be applicable to any other embodiment of the present invention.

As shown in FIG. 2, system 200 includes a receiving module 202, an issuing module 204, an updating module 206, a maintenance module 208, a validation module 210, a reporting module 212, a messaging module 214, and an uploading module 216.

In accordance with a preferred embodiment of the present invention, one or more modules, as shown in FIG. 2, form a part of a core banking solution such as banking solution 108.

Initially, when a customer such as customer 102 wishes to receive a cheque-book, he/she requests the bank to issue it. The customer can contact the bank either by visiting it or by sending a request to the bank through a device such as electronic device 104. Receiving module 202, as shown in FIG. 2, receives the customer's request. In accordance with an embodiment of the present invention, receiving module 202 may receive the request sent by the customer through multiple channels, as described above in FIG. 1. Receiving module 202 further interacts with validation module 210 and sends the request to validation module 210.

Validation module 210 validates the request to verify the customer's particulars such as residential details, demographic information, and signature. In accordance with another embodiment of the present invention, validation module 210 validates the request to ascertain whether the customer's account number exists. After validating the request, validation module 210 interacts with issuing module 204. Subsequently, issuing module 204 issues a cheque-book with one or more cheque leaves to the customer. Each cheque leaf can be used for conducting different financial transactions. While issuing the cheque leaves to the customer, issuing module 204 associates a default status to each cheque leaf. Various examples of the default status may include “Issued but not acknowledged for use” and “Unused”. Thereafter, issuing module 204 interacts with maintenance module 208; accordingly, maintenance module 208 maintains each cheque leaf's default status.

Once the cheque leaves are issued by the bank, they are acknowledged by the customer. Accordingly, the cheque leaves become ready for use by the customer. Based on the usage by the customer, each cheque leaf's default status is updated by updating module 206. Further, the default status is updated by appending a current status to the default status based on the occurrence of an event from a list of pre-defined events. Various examples of the pre-defined events may include, but are not limited to, “Issue of one or more cheque Leaves”, “Acknowledgement of one or more Cheque leaves”, “Transaction Maintenance”, “Inward Clearing”, “Stop Payment on a Cheque Leaf”, “Revoke Payment of a Stop Cheque Leaf”, “Removal of Caution”, and “Paid Cheque Leaf Return”. Moreover, updating module 210 facilitates a bank agent to manually modify the updated status, when required.

After updating the default status, maintenance module 208 maintains the updated status appended with the default status in a pre-defined format. The pre-defined format corresponds to a compact format of storing the default status and the updated status, and the process will be described in detail in conjunction with FIG. 3. In accordance with an embodiment of the present invention, the customer may inquire each cheque leafs updated status by sending a request through at least one of the multiple channels, as discussed above. Moreover, the request is received by receiving module 202.

In accordance with an embodiment of the present invention, validation module 210 validates each cheque leafs updated status based on one or more pre-defined conditions. The validation is performed to check the correctness of the updated status. Various examples of the pre-defined conditions may include, but are not limited to, a cheque leaf cannot be entered for payment when it is not issued, a cheque leaf cannot be stopped when it is issued, a cheque leaf cannot be passed like a normal cheque when a caution is marked, and a cheque leaf marked stopped, destroyed, not issued, and returned cannot be re-used for making a payment.

Furthermore, reporting module 212 as shown in FIG. 2 generates a report containing details associated with each cheque leaf of the cheque-book. The report is viewable by the customer. Reporting module 212 further maintains the details associated with each cheque leaf in a pre-determined format. For example, the details may be maintained in a summarized format. Accordingly, reporting module 212 displays the details associated with each cheque leaf in the form of a summary. Various examples of the details of the cheque leaf may include, but are not limited to, account number, cheque leaf number, cheque leaf type, status, function type, etc.

Moreover, messaging module 214 generates one or more messages based on each cheque leaf's updated status. Various examples of such messages may include, but are not limited to, error message, exception message, status successfully update message, and warning message.

Additionally, uploading module 216 uploads the details associated with each cheque leaf to a bank system. The details are uploaded to the bank system as a part of data migration. The details of each cheque leaf may include, account number, status of one or more cheque leaves, cheque leaves' serial number, customer name, account id, balance in the account, and so forth.

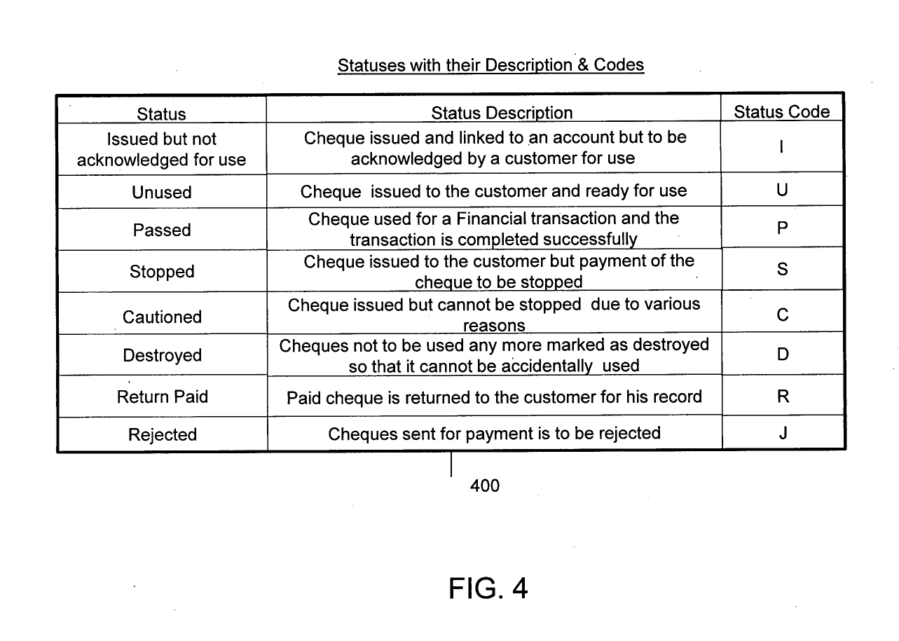

FIG. 3 represents a flow chart for maintaining a status corresponding to each cheque leaves of a cheque-book, in accordance with an embodiment of the present invention. To describe the flow chart illustrated in FIG. 3, references will be made to FIGS. 1, 2, 4, 5, 6, 7, 8, 9, 10, 11, 12, & 13, although, it will be apparent to those skilled in the art that the implementation details of the flowchart can be applicable to any other embodiment of the present invention.

The main objective of the flowchart as shown in FIG. 3 is to maintain multiple statuses of one or more cheque leaves of a cheque-book. Each cheque leaf can be used for conducting different financial transactions. The maintenance of the multiple statuses helps the customer to track the progress of each cheque leaf anytime during a life-cycle of the cheque leaf. Additionally, the maintenance of the multiple statuses facilitates an automatic control on the activities related to each cheque leaf during the life-cycle. Various examples of the multiple statuses discussed above include, “Issued but not acknowledged for use”, “Unused”, “Passed”, “Stopped”, “Cautioned”, “Destroyed”, “Return Paid”, “Rejected”, and so forth.

At 302, a cheque-book containing one or more cheque leaves is issued to a customer such as customer 102, by a bank. The cheque leaves may be issued to the customer based on the type of operative accounts he/she has with the bank. In accordance with an embodiment of the present invention, the cheque leaves may be issued based on a request received from the customer. The request may be sent by the customer through at least one of the multiple channels as described above. In accordance with another embodiment of the present invention, the cheque leaves may be issued as a part of opening an account with the bank. In accordance with further embodiment of the present invention, the cheque leaves may be issued based on the bank's re-order/re-issue policy. While issuing the cheque leaves to the customer, the bank associates a default status to each cheque leaf. The default status may be, for example, “Issued but not acknowledged for use” and “Unused”.

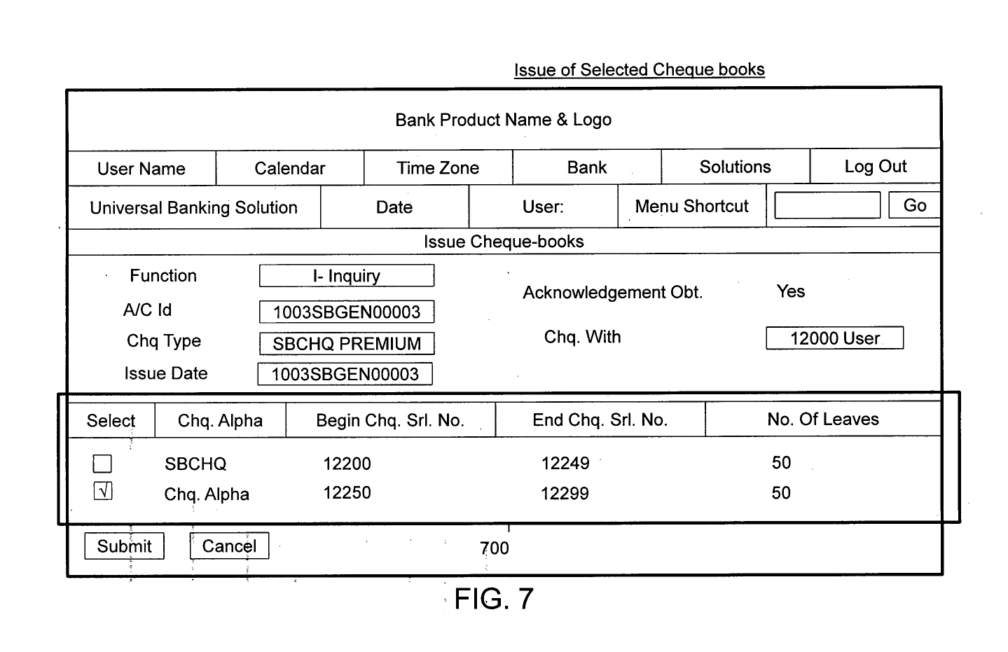

At the time of issuing the cheque leaves, a bank agent may require to fill various details, as shown in FIG. 7. The various details may include function, account id, cheque leaf type, acknowledgement, issued date, begin cheque leaf serial number, end cheque leaf serial number, number of cheque leaves, etc. Further, the cheque leaves shown as selected using a tick mark symbol in FIG. 7, are issued to the customer.

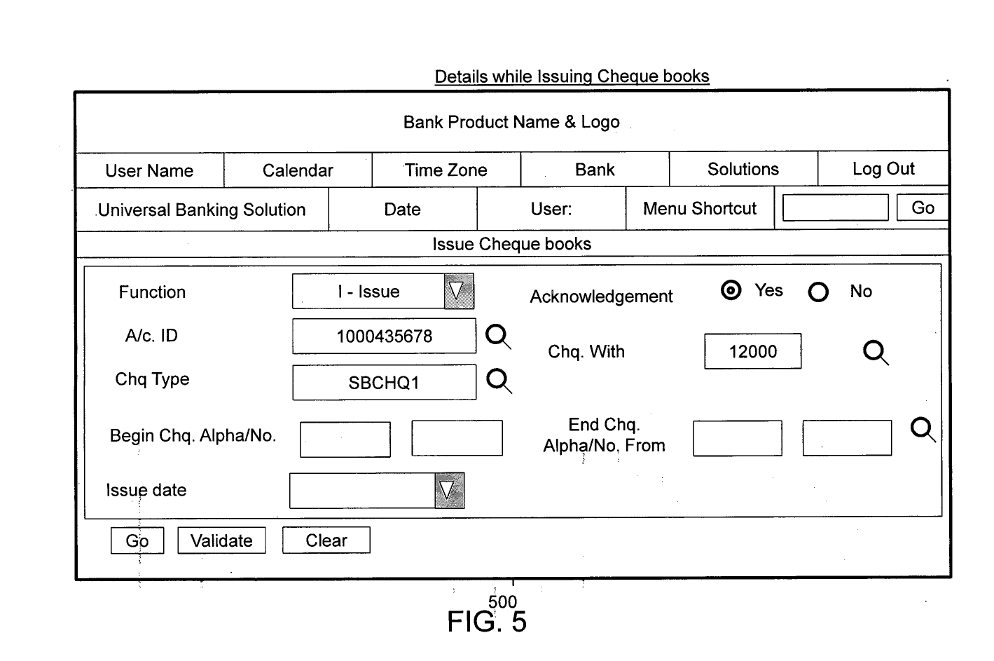

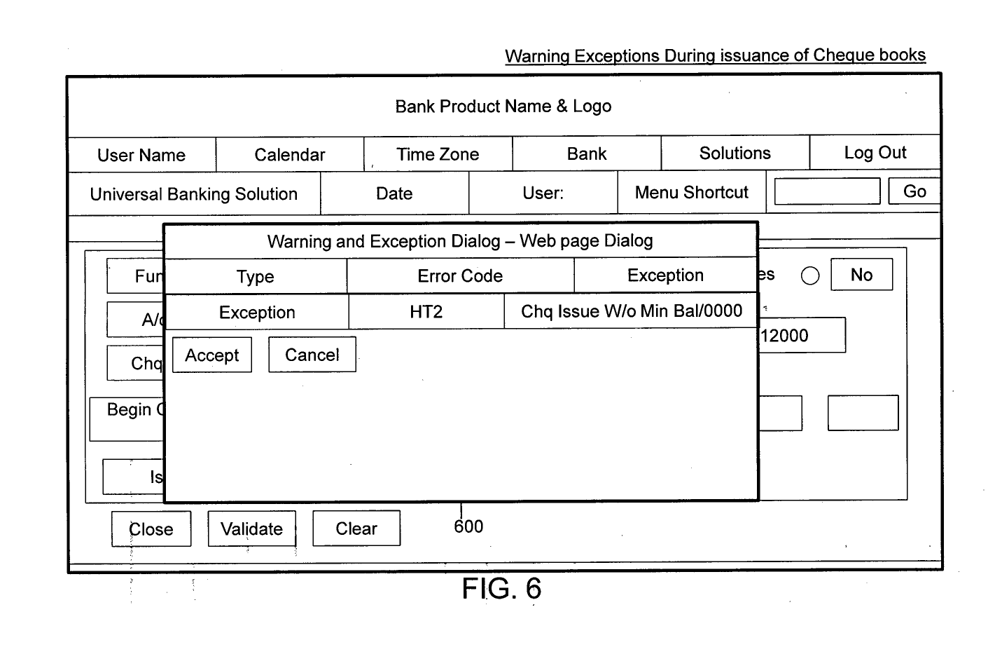

In accordance with an embodiment of the present invention, the cheque leaves are issued to the customer after validating the details, as shown in FIG. 5. For example, the validation is performed to ascertain whether the cheque leaves with the same cheque number are issued to the customer. In another example, the validation may be performed to ascertain whether the account number or the account id exists. In further example, the validation check may be performed to determine the balance in the customer's account. Accordingly, while validating these details, one or more warnings and exceptions may occur, as shown in FIG. 6. The warnings and exceptions occur in case of wrong entry, zero balance in the account, etc. The warning and exception is further displayed to the bank agent through a dialog box, as depicted in FIG. 6. The dialog box further demonstrates various details such as type of exception, error code, description of the exception, etc. Additionally, the framework, as shown in FIG. 5, exemplifies a core banking solution such as banking solution 108 used by the agents in the bank.

In accordance with a preferred embodiment of the present invention, only one status is applicable for each cheque leaf when the cheque leaves are in the bank's custody. This status is known as default status. Once the cheque leaves are issued to the customer for usage, multiple statuses are applicable at a given point of time. Various examples of the multiple statuses may include but are not limited to, “Issued but not acknowledged for use”, “Unused”, “Passed”, “Stopped”, “Revoked”, “Cautioned”, “Destroyed”, “Return Paid”, and “Rejected”. Moreover, a brief description of each of the multiple statuses and the corresponding status code will be described in the subsequent paragraphs. Additionally, each of the multiple statuses is associated with one or more pre-defined business processes, which will also be described below.

Status 1: “Issued but not acknowledged for use”

Description: The status depicted herein signifies the issuance of a cheque leaf to the customer. Further, the cheque leaf issued is linked to the customer's account, and each of the cheque leaf is yet to be acknowledged by the customer for use. This status may be referred to as a default status.

Code: The corresponding code for this status is “I”.

Business Process: The pre-defined business process associated with this status is “Cheque Issue Process” or “Cheque Status Maintenance”.

Status 2: “Unused”

Description: The status disclosed herein signifies that the cheque leaf issued to the customer is acknowledged by the customer, and further the cheque leaf is ready for use by the customer. This status may also be referred to as a default status.

Code: The status code is depicted as “U”.

Business Process: The pre-defined business process associated with this status corresponds to “Cheque Issue Process”.

Status 3: “Passed”

Description: The status outlined herein describes that the cheque leaf is used for a financial transaction, and further that the transaction is completed successfully.

Code: The code associated with this status is demonstrated as “P”.

Business Process: The pre-defined business process associated with this status is “Transaction Posting Process”.

Status 4: “Stopped”

Description: The status represented above expresses that the cheque leaf is issued to the customer, but the payment for the cheque leaf needs to be stopped. Further, stopping of the cheque leaf is performed due to loss of cheque or due to any other similar reasons.

Code: The status code for this is illustrated as “S”.

Business Process: In addition, the pre-defined business process associated with this status is “Stop Payment Process”.

Status 5: “Revoked”

This status signifies that the cheque leaf stopped for payment is revoked by the customer.

Function Code: The function code for this status is illustrated as “K”. The function code is available in the menu option of banking product. Further, the function code is used to initiate the operation of removing the “Stopped” status on a cheque leaf. Accordingly, the “Stopped” status of the cheque leaf is updated to “Unused” status so that the cheque leaf can be used by the account holder.

Business Process: In addition, the pre-defined business process associated with this status is “Revoke Stop Payment Process”.

Status 6: “Cautioned”

Description: The status depicted herein describes that the cheque leaf is issued to the customer, but payment on the cheque leaf cannot be stopped due to various reasons. This activity is performed when an owner of the cheque leaf is not available.

Code: The code for this status is depicted as “C”.

Business Process: Further, the pre-defined business process for this status is “Specific Cautioning Cheque Process”.

Status 7: “Destroyed”

Description: The status illustrated above indicates that the cheque leaf is not to be used by the customer any more. Such cheque leaf is marked as destroyed so that the cheque leaf is not accidently used by anyone. In general, the cheque leaf is destroyed when the customer's account needs to be closed. In such scenarios, either the cheque leaf issued to the customer is received by the bank or destroyed so that it cannot be accidently used by anybody.

Code: The code for this status is “D”.

Business Process: The pre-defined business process associated with this status is “Specific Destroy Function Cheque Process”.

Status 8: “Return Paid”

Description: The status mentioned above describes that the paid cheque leaf is returned to the customer for his/her records. It further signifies that the transaction conducted using the cheque leaf is completed successfully. In accordance with an embodiment of the present invention, certain insurance companies maintain this status.

Code: The code for this status is shown as “R”.

Business Process: Further, the pre-defined business process associated with this status is “Return Paid Processes”. “Return Paid Processes” is a menu option to identify: (i) all cheque leaves which are issued to the account holder and (ii) all cheque leaves with status “Passed” (P). In a scenario, when these cheque leaves are to be returned to the customer for a certain reason, a report of the identified cheques leaves is generated. As a part of this process, the menu option also marks the status of the corresponding cheque leaves as ‘R’ (Paid Cheque Returned). This helps in tracking the physical cheque leaves.

Status 9: “Rejected”

Description: The status depicted herein demonstrates that the cheque leaf sent for the payment needs to be rejected.

Code: The code for this status is represented as “J”.

Business Process: The pre-defined business process for this status is “Cheque Rejection Process”.

In addition to the statuses described above, the cheque leaf can have a status called “Transferred”. This status is applicable for situations when a customer has multiple accounts with cheque facility, and further the customer wishes to close any of his/her accounts. In particular, the status is pertinent when the customer wishes to transfer unused cheque leaves from one of his/her account to his/her other account. Further, two possible scenarios may occur based on the customer's needs. In one scenario, the customer wishes to transfer the cheque leaves from one of his/her account to another. In second scenario, the customer does not wish to transfer the cheque leaves from one account to another. If the customer wishes to go ahead with the option as described in scenario 1, then the cheque leaves can be re-used by the customer from his/her other account. Accordingly, the cheque leaves are marked as transferred in the first account and hence not available for use. Further, the cheque leaves are issued with the status “U” and linked to the customer's second account. However, if the customer wishes to proceed with the option discussed in scenario 2, then the cheques leaves are marked as destroyed before closing the account. The cheque leaves are marked as destroyed to ensure they are not accidentally used by anyone. Moreover, the code for the status as described above is depicted as “T”. Additionally, this activity of transferring the cheque leaves is performed by using a menu option facilitated by the banking solution.

Continuing with the description of flow chart, once the cheque leaves are issued to the customer, then he/she acknowledges that they have been received. Thereafter, at 304, the default status of each cheque leaf is updated by appending a current status to the default status. The current status is appended based on the occurrence of an event from a list of pre-defined events by using the pre-defined business processes as described above in detail. Various examples of the pre-defined events may include, but are not limited to, “Issue of one or more Cheque Leaves”, “Transaction Maintenance”, “Inward Clearing”, “Stop Payment of Cheque Leaf”, “Revoke Payment of a Stop Cheque Leaf”. “Removal of Caution”, and “Paid Cheque Leaf Return”.

In accordance with an exemplary embodiment of the present invention, the process of updating the default status is described herein. In accordance with this embodiment, it can be considered that the event of “Stop Payment of Cheque Leaf” occurs. This event occurs when the customer wishes to stop payment on the cheque leaf. When such event occurs, the banking solution automatically updates the default status from “U” to “S” by using a business process such as “Stop Payment Process”. Accordingly, the status is appended with the current status, and it is further maintained in the pre-defined format. Moreover, the process of updating the status is repeated when an event other than the event described above occurs. For example, it can be considered that an event such as “Revoke Payment of a Stop Cheque Leaf” occurs. Accordingly, the banking solution may update the status from “S” to “U”. While updating the status, the banking solution performs a validation check, for example, if the cheque leaf has been already stopped or not. Based on the validation check, the banking solution updates the status. For example, if the cheque leaf is already stopped, the banking solution does not allow the status change to take place. Otherwise, the status is updated from “S” to “U”.

In accordance with an embodiment of the present invention, the process of validating the status of each cheque leaf is described in greater detail. The validation helps to maintain the correct status of each cheque leaf. Further, the validation is performed based on one or more pre-defined conditions. Various examples of the pre-defined conditions may include, but are not limited to, a cheque leaf cannot be entered for payment when it is not issued, a cheque leaf cannot be stopped when it is issued, a cheque leaf cannot be passed like a normal cheque when a caution is marked, and a cheque leaf stopped, destroyed, not issued, returned cannot be re-used for making a payment. To elaborate this, an example discussed above is given below. According to the example, it can be assumed that the cheque leaf's current status is “Stopped”, denoted by “S”. It can be further considered that an event of “Transaction Processing” occurs on the cheque leaf. Then, the banking solution performs the validation based on the pre-defined conditions as described above. Accordingly, the banking solution determines that the cheque leaf stopped for making payment cannot be re-used for making payments. Thus, the banking solution does not allow the status change from “S” to “U”. Hence, the status of the cheque leaf is updated from “S” to “S”.

Once the status is updated, at 306, the updated status is maintained in a pre-defined format such as a compact format. The compact format of storing the status represents a way to store the status of multiple cheque leaves in just one record field. The record field has the ability to store the status of up to one thousand cheque leaves. Further, the length of the status may vary from 1 character up to 1000 characters.

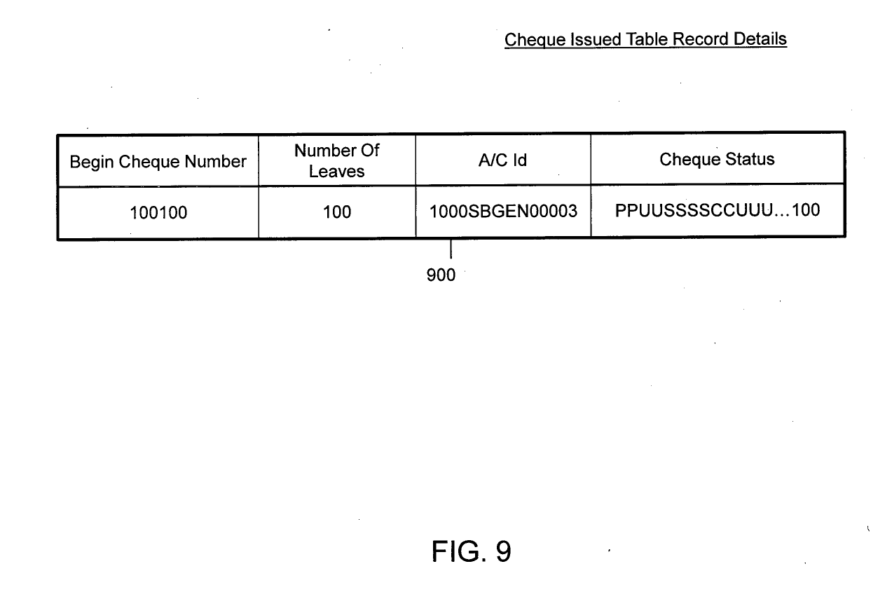

In accordance with an embodiment of the present invention, FIG. 9 illustrates a table depicting various details maintained by the banking solution, for example, begin cheque number, total number of cheque leaves in a cheque-book, account ID, and the cheque status. The “cheque status” field, as shown in FIG. 9 is a field having the capability to store the status of multiple cheque leaves. As depicted in the figure, these multiple status codes maintained in this field are interpreted as: cheque leaf number 100100 corresponds to “P”, and hence the status of the cheque leaf 100100 is “Passed”. Further, cheque leaf number 100101 corresponds to “P”, and hence the status of the cheque leaf 100101 is “Passed”, and cheque leaf number 100102 corresponds to “U”, and hence the status of the cheque leaf 100102 is “Unused”. Further, cheque leaf number 100103 corresponds to “U”, and hence the status of the cheque leaf 100103 is “Unused”. Moreover, cheque leaves 100104-5 correspond to “S”, and hence statuses of the cheque leaves 100104-5 are “Stopped”. Further, cheque leaves 100106-8 correspond to “S”, and hence statuses of these cheque leaves are “Stopped”. Additionally, cheque leaves 100107-99 have status “U”, and hence all remaining cheque leaves from 100107 to 101199 are “Unused”. Thus, the record field “cheque status” can store the status of up to 1000 cheque leaves issued to the customer's account. The combination of the multiple statuses exists as part of one cheque-book issue record but clearly identifiable based on the position of the status in column with respect to the cheque leaf.

In accordance with another embodiment of the present invention, the compact format of maintaining the statuses has been illustrated below.

| Cheque Leaf Number | Issued Date | Cheque leaf statuses |
|---|---|---|
| 100100 | XXXXXXXX | I, U, P |
| 100102 | XXXXXXXX | U, S, C, P |

According to this embodiment, the cheque leaf's default and the current status are appended and maintained in a single field such as “Cheque leaf statuses”. Additionally, the one or more statuses will be appended based on the occurrence of events described above.

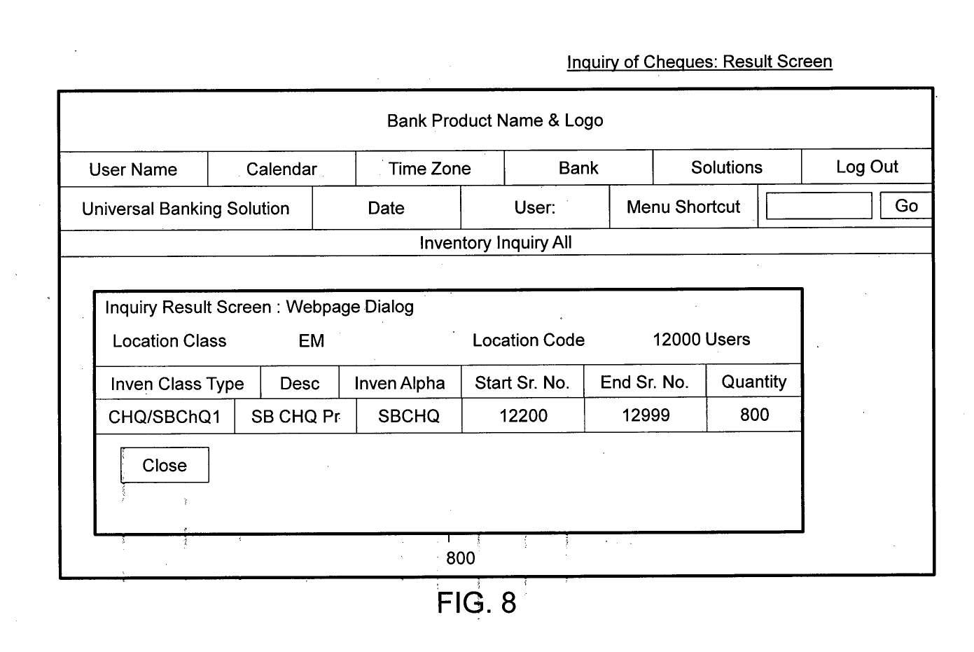

In accordance with an embodiment of the present invention, the customer may enquire each cheque leaf's status through at least one of the pre-defined channels described above. The customer may enquire each cheque leaf's status at regular time periods, for example, once a week, twice a week, once in a month, etc. The result screen of each cheque leaf's status enquiry may be displayed to the customer, as shown in FIG. 8.

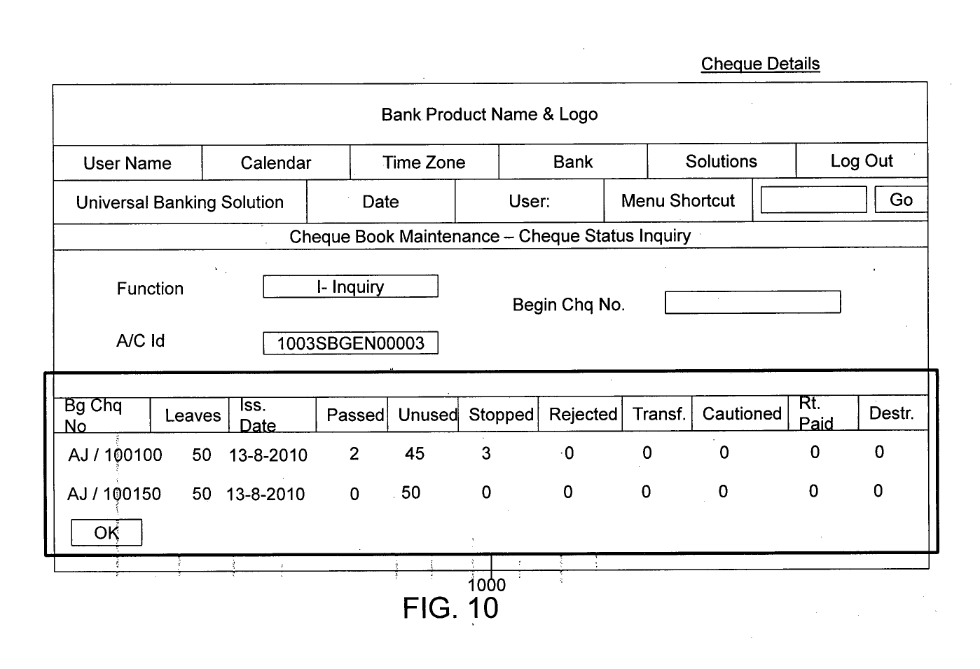

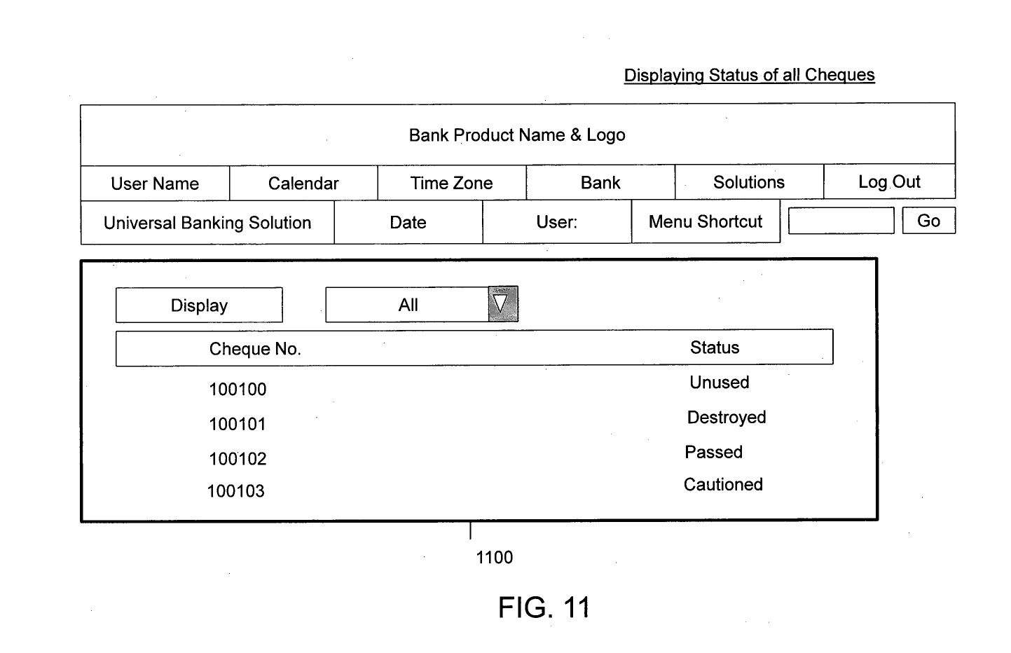

In accordance with an embodiment of the present invention, the customer may view comprehensive summary associated with the cheque leaves of a cheque-book, as shown in FIG. 10. Further, the details may include the total number of cheque leaves issued to the customer, date of issuance of the cheque leaves, cheque leaves with status “P”, cheque leaves with status “U”, and so on. In accordance with another embodiment of the present invention, the customer may view each cheque leaf's status that form a part of the cheque-book, as depicted in FIG. 11. In accordance with this embodiment, FIG. 11 shows that the status of cheque leaf 100100 is “Unused”, while the status of cheque leaf 100101 is “Destroyed”, and so on.

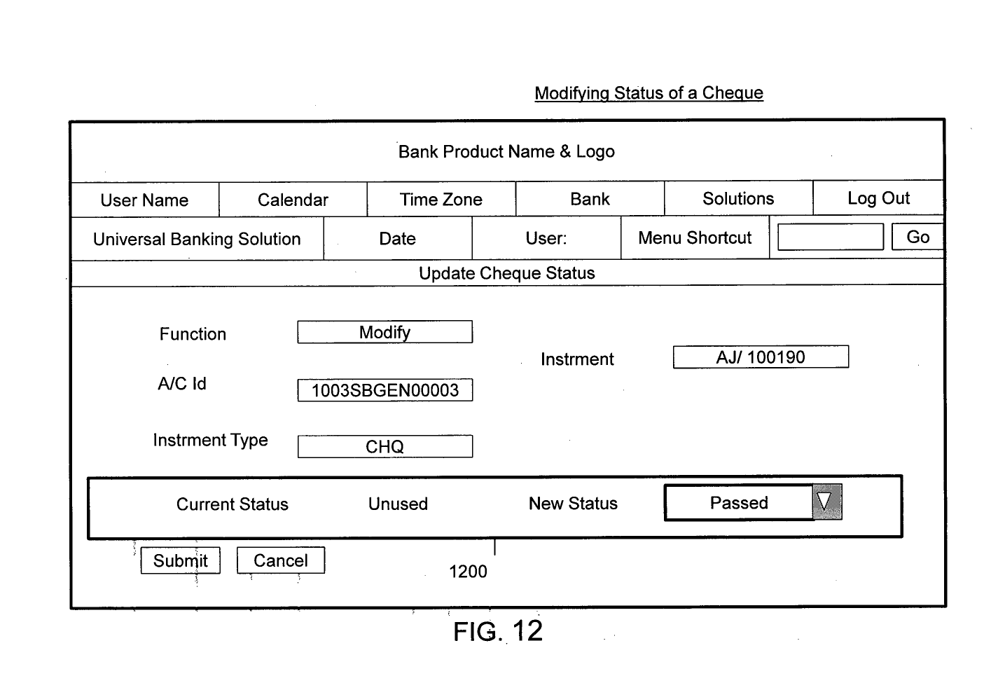

In accordance with an embodiment of the present invention, the banking solution as described above, allows the bank agent to modify the cheque leaf's status to make corrections when required, as shown in FIG. 12. For example, the bank agent may need to modify the status in case of wrong entry and so forth. Further, the bank agent may modify the status by using function “modify”, as shown in FIG. 12. In accordance with this embodiment, it can be assumed that cheque leaf leaves 100100 to 100199 are, issued to the customer's account. It can be further stated that the customer uses the cheque leaf 100109 for transaction. However, the teller machine inputs the cheque leaf number as 100190 or the bank agent enters the cheque leaf number wrongly as 100190. Since both the cheque leaves have been issued, the transaction will be carried out. After the transaction, the status of cheque leaf 100190 becomes “P”. Further, when the actual cheque leaf 100190 is presented, the banking solution will indicate this cheque leaf is already passed. To encounter such scenarios, the option of manual status change may be used by the bank agent. Accordingly, this option is used for changing the status from “U” to “P” of cheque leaf 100109 or “P” to “U” of cheque leaf 100190.

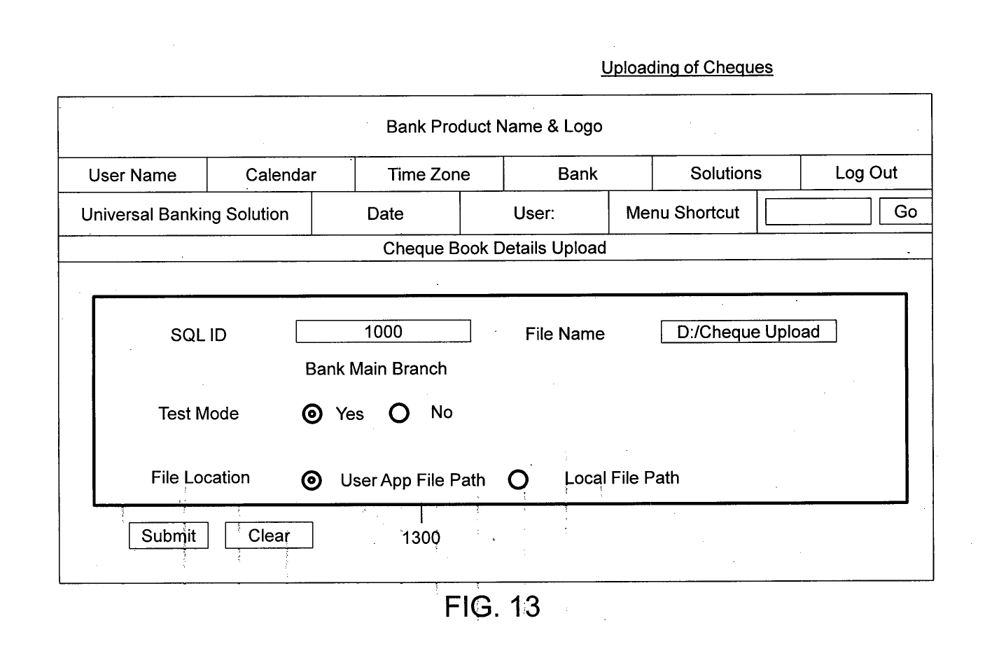

In accordance with an embodiment of the present invention, the banking solution provides the option of uploading the details of one or more cheque leaves to a new system when required. For example, the details may be uploaded when the existing data is migrated to the new system, as illustrated in FIG. 13. The details of the cheque leaves to be uploaded may be account number, cheque leaf number, status, etc.

In accordance with an embodiment of the present invention, a table has been depicted below to show multiple statuses of cheque leaves. The table shows that the multiple statuses listed in column I can be changed to one or more statuses as listed as in Column II. However, the multiple statuses as shown in column I cannot be changed to one or more statuses as shown in column III.

| | Can change to status | Cannot change to |
|---|---|---|
| Status (Column I) | (Column II) | (Column II) |
| I—Issued but not | U | P, S, C, J, and D |
| acknowledged for use | | |
| U—Unused | S, C, P, J, D | I |
| P—Paid | U | S, C, I, |
| S—Stopped | U | P, C, I |
| C—Cautioned | S, P, D, J, U | I, |
| D—Destroyed | — | P, U, S, C, J |

In accordance with an embodiment of the present invention, a table is shown below to illustrate multiple statuses and corresponding validations. To elaborate this, column I depicts various event codes, and the corresponding description has been illustrated in column II. Moreover, Column III defines various validations for each of the statuses as discussed above. Additionally, column IV shows the status change based on the occurrence of corresponding events, as illustrated in column I.

| Event | | | |
|---|---|---|---|
| option | Description | Validation | Status change |
| HICHB | Issue of | (i)Validity of the account; | I - with |
| | Cheque | (ii) Same account ID or | acknowledgement |
| | Leaves | number already exists | U - without |
| | | or not | acknowledgement |
| HTM | Transaction | (i) Cheque leaf is issued | From U to P |
| | Maintenance | or not | |
| | | (ii) Cheque leaf is not | |
| | | stopped; | |
| | | (iii) Cheque leaf is not | |
| | | already paid | |
| | | (iv) Cheque leaf is not | |
| | | destroyed | |
| | | (v) Cheque leaf is not | |
| | | cautioned | |
| ICTM | Inward | Above validations | U to P |
| | Clearing | | |
| SPP | Stop Payment | (i) Cheque leaf is issued, | U to S |
| | of | (ii) Cheque leaf is not | Or |
| | Cheque Leaf | already paid, | C to S |
| | | (iii) Cheque leaf is not | |
| | | already stopped | |
| SPP | Revoke Stop | Cheque leaf is already | S to U |
| | Payment of a | stopped or not | |
| | Cheque Leaf | | |
| CHBM | Cheque-book | Cheque leaf is issued and | U to D |
| | maintenance | not paid | U to C |
| | Can mark it | | |
| | as destroyed, | | |
| | cautioned | | |
| CHBM | Removal of | Cheque leaf is already | C to U |
| | Caution | cautioned or not | |
| Batch | Paid Cheque | Cheque leaf is already | P to R |
| Job | Leaf Return | paid | |

In accordance with an embodiment of the present invention, the format of storing the details of the cheque leaves has been described below. The various details of the cheque leaf include field name, description, field type and size and comments. In particular, field name illustrates one or more parameters maintained by the banking solution for each cheque leaf. Further, the description section illustrates the meaning of the parameters shown in column I. Moreover, field type & size signifies the type in which the field can be defined such as char and varchar. It further defines the size of storing the parameters, such as varchar 16 bytes, char 4 bytes, and number 4 bytes.

| | | Field | |
|---|---|---|---|
| | | type | |
| Field Name | Description | & size | Comments |
| begin_chq_num | Starting cheque | Varchar | Starting number of |
| | leaf number | (16 char) | the cheque leaves |
| acid | Account Id or | char | Account number to |
| | Account number | (4 char) | which the cheque |
| | | | leaves are issued |
| begin_chq_alpha | Pre-fix | Varchar | |
| | characters | (6 char) | |
| chq_issu_date | Date of issue | Date | Date of issue of |
| | | | cheque leaves |
| chq_num_of_lvs | Number of | number | Number of leaves |
| | cheque leaves | (4) | issued. It can be |
| | issued | | maximum of 1000 |
| chq_lvs_stat | Status of | Varchar | Current Status of |
| | cheque leaves | (1000 | the cheque |
| | | char) | |
| chq_issu_auth_id | Who issued the | Varchar | A banking agent |
| | cheque leaves | (15 char) | who issued to the |
| | | | cheque leaves to |
| | | | the customer |

In accordance with an embodiment of the present invention, the methodology disclosed in the present invention may be implemented for banking solutions/products, such as Finacle™ from Infosys Technologies®. In accordance with this embodiment, Finacle™ further provides a menu option such as HCHBM for maintaining multiple statuses of the cheque leaves. Further, this menu option also provides facility to: inquire status of all cheque leaves, view a summary of the cheque leaves issued to the customer and the details of the status of each cheque leaf when needed. Additionally, Finacle™ provides facility for Straight through Processing (STP) for updating of stop payment through different channels. In general, STP is a process which enables a user to initiate a request of updating a status such as “Stopped”, through multiple channels. After receiving the request, the status can be updated immediately considering the business criticality. For example, Finacle™ provides a provision for updating the status of a cheque leaf to “Stopped” status through various channels such as, Telephone banking, Internet banking, and Mobile banking. Hence, when the option for stopping is used through any of the above mentioned channels, marking the cheque leaves as ‘stopped’ can be done immediately in Finacle™.

In addition to the embodiments described above, the invention has been explained with the help of an example for ease. In this exemplary embodiment, it can be assumed that five cheque leaves are issued to the customer with status “I”. The status “I” of each cheque leaf is maintained by the banking solution. Further, it can be considered that an event “Acknowledgment of one or more Cheque Leaves” occurs. The occurrence of this event illustrates that the cheque leaves issued by the bank with status “I” are acknowledged by the customer. Accordingly, the status “I” is updated to “U” to exemplify that the cheque leaves are acknowledged by the customer and are ready for use by him/her. While updating the status, the banking solution performs one or more validation checks to validate the correctness of the updated status. Accordingly, the updated status appended with the default status is maintained by the banking solution. Further, it can be assumed that an additional event such as “Transaction maintenance” occurs. The event demonstrates that the customer has conducted a financial transaction using a cheque leaf of the five cheque leaves. Before updating the status, one or more validation checks are performed. The validation checks can be, for example, cheque leaf is issued or not, cheque leaf is not stopped, cheque leaf is not already paid, cheque leaf is not destroyed, and cheque leaf is not cautioned. Thereafter, the banking solution updates the cheque leaf's status from “U” to “P” to show that the financial transaction is conducted successfully. Accordingly, the status is updated and maintained further in the pre-defined format, as described above. Additionally, the cycle of updating and maintaining the status is repeated based on the occurrence of one or more different events, as discussed above.

The present invention described above has many advantages. The present invention facilitates a unique approach for maintaining multiple statuses of each cheque leaf of a cheque-book. The maintenance of the multiple statuses enables the customer to track each cheque leaf's progress when required. In addition, the present invention allows the customer to enquire the status of each cheque leaf anytime through multiple channels. The present invention further facilitates an automated approach of maintaining and updating one or more statuses of each cheque leaf. Thereby, manual intervention for maintaining and updating the one or more statuses of each cheque leaf is eliminated. Further, the present invention provides an automatic approach for validating the correctness of the one or more statuses of each cheque leaf. Moreover, the present invention facilitates a compact way for maintaining the multiple statuses of each cheque leaf. In addition to this, the present invention facilitates an automatic control on the activities related to each cheque leaf during the cheque leaf's life-cycle. For example, the present invention assists in preventing the occurrence of fallacious activities on each cheque leaf, such as duplicate payment on a cheque, payment on a stopped cheque, thereby reducing the wrong payment in each cheque life-cycle.

The method and system for maintaining a status corresponding to each cheque leaves of a cheque-book, or any of its components, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically, comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions (or program instructions) that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions (a program instruction means) can be embedded in a computer program product for use with a computer, the computer program product comprising a computer usable medium with a computer readable program code embodied therein. Processing of input data by the processing machine may be in response to users' commands, results of previous processing, or'a request made by another processing machine.

The modules described herein may include processors and program instructions that are used to implement the functions of the modules described herein. Some or all the functions can be implemented by a state machine that has no stored program instructions, or in one or more Application-specific Integrated Circuits (ASICs), in which each function or combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

1. A method for maintaining a status corresponding to each of one or more cheque leaves of a cheque-book, the method comprising:
issuing, with a financial computing device, the one or more cheque leaves to a customer, each of the one or more cheque leaves having a status as a default status;
updating, with the financial computing device, the status by appending a current status to the status of each of the one or more cheque leaves, the current status being appended based on the occurrence of an event from a list of pre-defined events; and
maintaining, with the financial computing device, the status of each of the one or more cheque leaves in a pre-defined format,
wherein the updating and the maintaining are repeated to further update and maintain the status when at least one event from the list of pre-defined events occurs, the at least one event being different from the event,
wherein the status depicting a plurality of statuses of a life-cycle stage of each of the one or more cheque leaves.

2. The method according to claim 1, wherein each of the one or more cheque leaves is used for conducting a financial transaction.

3. The method according to claim 1, wherein the one or more cheque leaves are issued when a request from the customer is received.

4. The method according to claim 2, wherein the request from the customer is received through at least one of one or more pre-defined channels.

5. The method according to claim 2, wherein the request received from the customer is validated.

6. The method according to claim 1 further comprising updating, with the financial computing device, the status by using one or more pre-defined business processes.

7. The method according to claim 1 further comprising validating, with the financial computing device, the updated status of each of the one or more cheque leaves based on one or more pre-defined conditions.

8. The method according to claim 1 further comprising receiving, with the financial computing device, a request from the customer for inquiring the updated status of each of the one or more cheque leaves, the request being received through at least one of pre-defined channels.

9. The method according to claim 1 further comprising generating, with the financial computing device, one or more messages based on the updated status of each of the one or more cheque leaves.

10. The method according to claim 1 further comprising modifying, with the financial computing device, the updated status by a bank agent.

11. The method according to claim 1 further comprising generating, with the financial computing device, a report comprising details associated with each of the one or more cheque leaves.

12. The method according to claim 11 further comprising maintaining, with the financial computing device, the details associated with each of the one or more cheque leaves in a pre-determined format.

13. The method according to claim 11 further comprising displaying, with the financial computing device, the details associated with each of the one or more cheque leaves.

14. The method according to claim 11 further comprising uploading, with the financial computing device, the details associated with each of the one or more cheque leaves to a bank system.

15. A method for maintaining a plurality of statuses corresponding to each of one or more cheque leaves of a cheque-book, each of the plurality statuses depicting a corresponding life-cycle stage of a cheque leaf, the method comprising:
assigning, with a financial computing device, a default status to each of the one or more cheque leaves, the default status being assigned to each of the one or more cheque leaves while issuing the-cheque-book to a customer; and
maintaining, with the financial computing device, the default status and one or more statuses corresponding to the cheque leaf, wherein each status of the one or more statuses being assigned to the cheque leaf based on the occurrence of a corresponding event from a list of pre-defined events.

16. The method according to claim 15, wherein each of the one or more cheque leaves is used for conducting a financial transaction.

17. The method according to claim 15, wherein the one or more cheque leaves are issued when a request from the customer is received.

18. The method according to claim 15, wherein the request from the customer is received through at least one of one or more pre-defined channels.

19. The method according to claim 15, wherein the request received from the customer is validated.

20. A financial computing device comprising:
a memory; and
a processor coupled to the memory and configured to execute programmed instructions stored in the memory, comprising:
issuing one or more cheque leaves to a customer, each of the one or more cheque leaves having a status as a default status;
updating the status by appending a current status to the status of each of the one or more cheque leaves, the current status being appended based on the occurrence of an event from a list of pre-defined events; and
maintaining the status of each of the one or more cheque leaves in a pre-defined format,
wherein the updating module and the maintaining are repeated to further update and maintain the status when at least one event from the list of pre-defined events occurs, the at least one event being different from the event,
wherein the status depicting a plurality of statuses of a life-cycle stage of each of the one or more cheque leaves.

21. The system device according to claim 20, wherein each of the one or more cheque leaves is used for conducting a financial transaction.

22. The device according to claim 20 wherein the processor is further configured to execute programmed instructions stored in the memory further comprising receiving a request from the customer for issuing the one or more cheque leaves.

23. The device according to claim 22, wherein the processor is further configured to execute programmed instructions stored in the memory for the receiving further comprising receiving the request through at least one of one or more pre-defined channels.

24. The device according to claim 22, wherein the processor is further configured to execute programmed instructions stored in the memory for the receiving further comprising receiving a request from the customer for inquiring the updated status of each of the one or more cheque leaves, the request being received through at least one of pre-defined channels.

25. The device according to claim 22 the processor is further configured to execute programmed instructions stored in the memory further comprising validating the request received from the customer.

26. The device according to claim 25, wherein the processor is further configured to execute programmed instructions stored in the memory for the validating further comprising validating the updated status of each of the one or more cheque leaves based on one or more pre-defined conditions.

27. The device according to claim 20, wherein the processor is further configured to execute programmed instructions stored in the memory for the updating further comprising updating the status by using one or more pre-defined business processes.

28. The device according to claim 20, wherein the processor is further configured to execute programmed instructions stored in the memory for the updating further comprising modifying the updated status by a bank agent.

29. The device according to claim 20 wherein the processor is further configured to execute programmed instructions stored in the memory further comprising generating one or more messages based on the updated status of each of the one or more cheque leaves.

30. The device according to claim 20 wherein the processor is further configured to execute programmed instructions stored in the memory further comprising generating a report comprising details associated with each of the one or more cheque leaves.

31. The device according to claim 30, wherein the processor is further configured to execute programmed instructions stored in the memory for the generating the report further comprising maintaining the details associated with each of the one or more cheque leaves in a pre-determined format.

32. The device according to claim 30, wherein the processor is further configured to execute programmed instructions stored in the memory for the generating report further comprising displaying the details associated with each of the one or more cheque leaves.

33. The device according to claim 30 wherein the processor is further configured to execute programmed instructions stored in the memory further comprising uploading the details associated with each of the one or more cheque leaves to a bank system.

34. A non-transitory computer readable medium having stored thereon instructions for maintaining a status corresponding to each of one or more cheque leaves of a cheque-book, comprising machine executable code which when executed by a processor, causes the processor to perform steps comprising:
issuing the one or more cheque leaves to a customer, each of the one or more cheque leaves having a status as a default status;
updating the status by appending a current status to the status of each of the one or more cheque leaves, the current status being appended based on the occurrence of an event from a list of pre-defined events; and
maintaining the status of each of the one or more cheque leaves in a pre-defined format,
wherein the updating and the maintaining are repeated to further update and maintain the status when at least one event from the list of pre-defined events occurs, the at least one event being different from the event,
wherein the status depicting a plurality of statuses of a life-cycle stage of each of the one or more cheque leaves.

35. The computer program product according to claim 34, wherein each of the one or more cheque leaves is used for conducting a financial transaction.

36. The medium according to claim 34, wherein the one or more cheque leaves are issued when a request from the customer is received.

37. The medium according to claim 36, wherein the request from the customer is received through at least one of one or more pre-defined channels.

38. The medium according to claim 36, wherein the request received from the customer is validated.

39. The medium according to claim 34 further comprising machine executable code which, when executed by the processor, causes the processor to perform steps further comprising updating the status by using one or more pre-defined business processes.

40. The medium according to claim 34 further comprising machine executable code which, when executed by the processor, causes the processor to perform steps further comprising validating the updated status of each of the one or more cheque leaves based on one or more pre-defined conditions.

41. The medium according to claim 34 further comprising machine executable code which, when executed by the processor, causes the processor to perform steps further comprising receiving a request from the customer for inquiring the updated status of each of the one or more cheque leaves, the request being received through at least one of one or more pre-defined channels.

42. The medium according to claim 34 further comprising machine executable code which, when executed by the processor, causes the processor to perform steps further comprising generating one or more messages based on the updated status of each of the one or more cheque leaves.

43. The medium according to claim 34 further comprising machine executable code which, when executed by the processor, causes the processor to perform steps further comprising modifying the updated status by a bank agent.

44. The medium according to claim 34 further comprising machine executable code which, when executed by the processor, causes the processor to perform steps further comprising generating a report comprising details associated with each of the one or more cheque leaves.

45. The medium according to claim 44 further comprising machine executable code which, when executed by the processor, causes the processor to perform steps further comprising maintaining the details associated with each of the one or more cheque leaves in a pre-determined format.

46. The medium according to claim 44 further comprising machine executable code which, when executed by the processor, causes the processor to perform steps further comprising displaying the details associated with each of the one or more cheque leaves.

47. The medium according to claim 34 further comprising machine executable code which, when executed by the processor, causes the processor to perform steps further comprising uploading the details associated with each of the one or more cheque leaves to a bank system.
